(19) United States
(12) Patent Application Publication
(10) Pub. No.: US 2007/0031534 A1
(43) Pub. Date: Feb. 8, 2007

(54) Pet food for reducing food allergy reactions

(76) Inventors: Hajime Tsujimoto, Tokyo (JP); Kenichi Masuda, Kanagawa (JP); Jun Ishihara, Ibaraki (JP); Masahiro Kaneko, Ibaraki (JP); Yoshikazu Hatano, Ibaraki (JP); Tadashi Sakurai, Ibaraki (JP); Masahiro Yamaguchi, Gifu (JP)

Correspondence Address: BIRCH STEWART KOLASCH & BIRCH, PO BOX 747, FALLS CHURCH, VA, 22040-0747, US

(21) Appl. No.: 10/590,725

(22) PCT Filed: Feb. 25, 2005
(86) PCT No.: PCT/JP05/03680

§ 371 Date: Aug. 25, 2006

(30) Foreign Application Priority Data
Feb. 27, 2004 (JP) 2004-055171
Feb. 25, 2005 (JP) 2005-050003

(51) Int. Cl. A23K 1/18

(52) U.S. Cl. 426/2

(57) ABSTRACT

As a pet food produced to contain no proteins that can become allergens, a pet food that contains 1 or more types of amino acids or salts thereof instead of protein raw materials that can become allergens or a pet food produced to contain, in addition to the above amino acid(s), 1 or more types of protein raw materials with low allergenicity selected from any of potato, sweet potato, rice, foxtail millet, barnyard millet, kaoliang, corn, pea, brewer's yeast, and baker's yeast is provided.

### TECHNICAL FIELD

The present invention relates to a pet food for reducing food allergy reactions.

### BACKGROUND ART

Proteins in foods are essential nutrients required for the growth of animals and the functions and maintenance of animal bodies. The same applies to the relationship between pets and pet foods. However, when an animal is allergic to a food, its in vivo immune system wrongly recognizes a protein contained in the ingested food as an antigen, so that hypersensitivity causes the development of inflammation in or on the skin and mucosa. Many pets develop inflammation in response to animal protein sources. In recent years, the number of cases of pets diagnosed with food allergic diseases is increasing. Food allergies are caused as follows. When an allergen existing in a protein in a food is incorporated by an antigen-presenting cell, it is presented as a T-cell antigenic determinant to T lymphocytes. Based on this antigen information, IgE against the allergen in a food is produced by the thus-stimulated B lymphocytes. IgE adheres to mast cell surfaces. When IgE recognizes a food antigen via the B-cell antigenic determinant of the food allergen, IgE causes the mast cells to release histamine. Thus, an allergic reaction occurs. To reduce food allergy reactions, a plurality of protein sources that are unlikely to become allergens are selected for use from various raw materials composing pet foods. Alternatively, hydrolysed peptides are used, which are prepared by degrading proteins to lower their molecular weights, so as to prevent proteins from becoming allergens (Kenichi Masuda, SA Medicine, Vol. 4, No. 2, pp. 57-60, 2002).

However, when an animal is allergic to a food, a food allergy reaction is not always caused by a single type of protein source. Such an animal subject to food allergies may also react to a plurality of allergens. Hence, the greater the number of types of protein sources in a food, the higher the risk of causing a food allergy reaction. Furthermore, even when a protein source that is currently thought to be unlikely to become an allergen is used, if a type of the protein source is close to the type of an allergen already existing in an animal, the T-cell antigenic determinant and the B-cell antigenic determinant are often the same for such allergen and protein source. In such a case, an allergic reaction can occur. Moreover, antigen-presenting cells recognize a peptide having a lower molecular weight as a result of hydrolysis, so as to transmit the relevant T-cell antigenic determinant to T lymphocytes. As a result, allergic reactions can occur or pets can show a tendency to experience diarrhea or soft feces. Hence, the use of such low molecular weight peptides is unsatisfactory. Some attempts have been made whereby homemade pet foods are prepared so as not to provide proteins that could be allergens. Such attempts are problematic in that such homemade pet food cannot be immediately provided when needed because preparation thereof takes much effort and such pet food cannot be stored. It is also difficult to provide all the essential nutrients to a pet in just proportion, so that body weight loss can be caused due to malnutrition, and such homemade pet food has low palatability. As described above, development of a pet food that can reduce the risk of the occurrence of a food allergy reaction and that can be conveniently used for feeding pets has been desired.

All publications, patents, and patent applications cited herein are incorporated herein by reference in their entirety.

### DISCLOSURE OF THE INVENTION

An object of the present invention is to provide a pet food that enables the reduction of the occurrence of food allergy reactions and can be conveniently used for feeding a pet.

According to the present invention, an amino acid or a salt thereof that is a minimum constitutional unit of a protein is provided as a substitute for a protein source in a pet food. Alternatively, according to the present invention, an amino acid or a salt thereof and a protein with low allergenicity are used as raw materials. These raw materials are heat-extruded and molded using an extruder, swelled, and then foamed, for example. The thus produced pet foods can be conveniently used by users for feeding their pets, can be easily stored, have good palatability, and satisfy requirements for essential nutrients for pets. Such pet foods enable reductions in the occurrence of food allergy reactions and can contribute to pet health.

Specifically, the present invention relates to a pet food for reducing food allergy reactions, which contains 1 or more types of amino acids or salts thereof instead of a protein raw material.

Furthermore, the present invention relates to a pet food for reducing food allergy reactions, which contains a plant protein raw material with low allergenicity and 1 or more types of amino acids or salts thereof.

Furthermore, the present invention relates to a pet food for reducing food allergy reactions, which contains 1, 2, or more types of raw materials selected from potato, sweet potato, rice, foxtail millet, barnyard millet, kaoliang, corn, pea, brewer's yeast, and baker's yeast, and 1 or more types of amino acids or salts thereof instead of a protein raw material.

Examples of the above amino acids include alanine, arginine, asparagine, aspartic acid, methionine, cystine, cysteine, glutamic acid, glutamine, glycine, threonine, histidine, valine, leucine, isoleucine, lysine, tryptophan, phenylalanine, tyrosine, proline, serine, and taurine. 1, 2, or more types of such amino acids are used. Examples of plant protein raw materials with low allergenicity include potato, sweet potato, rice, foxtail millet, barnyard millet, kaoliang, corn, and pea. Examples of protein raw materials other than such plant protein raw materials with low allergenicity include brewer's yeast and baker's yeast. 1, 2, or more types of such protein raw materials are used.

### BRIEF DESCRIPTION OF THE DRAWINGS

FIG. 1 shows the reaction of serum IgE of dogs subject to food allergies with a dog food extract. In the Western blot figure, 1 indicates the dog food and 2 indicates a beef extract (positive control). In addition, no ingredients reacting with the serum IgE of the dogs subject to food allergies were detected.

FIG. 2 shows the reactivity (case 1 and case 2) of lymphocytes against the dog food extract in dogs subject to food allergies.

FIG. 3 shows the proportions of food intake (the amount of food provided was determined to be 100).

FIG. 4 shows body weight changes.

FIG. 5 shows hematocrit changes.

FIG. 6 shows hemoglobin changes.

FIG. 7 shows blood total protein changes.

FIG. 8 shows blood albumin changes.

FIG. 9 shows the properties of feces. In FIG. 9, the conditions of feces were evaluated on 9 levels (on scores between 1 and 5). Scores between 1.5 and 2.5 indicate the normal conditions of feces.

FIG. 10 shows itching scores of dogs fed with the dog food.

FIG. 11 shows changes (−1) in itching scores of dogs fed with the dog food.

FIG. 12 shows changes (−2) in itching scores of dogs fed with the dog food.

FIG. 13 shows changes in itching scores of dogs fed with the dog food.

FIG. 14 shows the reaction of lymphocytes in dogs fed with the dog food.

FIG. 15 shows the reactivity of lymphocytes against the dog food extract in a dog subject to a food allergy.

The present invention is explained in detail as follows. This application claims priority of Japanese patent application No. 2004-55171 filed on Feb. 27, 2004, claims a priority of Japanese patent application No. 2005-50003, and encompasses the content described in the claims, description, and drawings of this patent application.

An amino acid is the smallest unit of a protein. Unlike proteins, peptides, or the like, an amino acid will never be recognized as a food allergy antigen when it is ingested from food. When an amino acid is ingested from a pet food, no food allergy reaction is caused in a pet subject to a food allergy. Thus, amino acids are effective for reducing food allergy reactions. Moreover, the use of an amino acid alone instead of a protein has never exerted particular adverse effects on pet health.

An amino acid or a salt thereof and 1 type of raw material containing a protein that becomes with difficulty an allergen of a food allergy are combined. Such combination enables reduction in the risk of the occurrence of a food allergy to a greater extent than that in a case of using raw materials containing a plurality of proteins. Furthermore, such combination can not only maintain the amino acid balance in a pet food that has poor balance because of the presence of 1 type of raw material containing a protein, but can also satisfy amino acid requirements for a pet.

Amino acids or salts thereof that are used in the present invention may be any amino acids or salts thereof, regardless of their types. At least 1 type of amino acid or a salt thereof may be contained. A more preferable result for maintenance of pet health can be obtained if 10 types of essential amino acids are contained. As such amino acids or salts thereof, amino acids or salts thereof produced by a standard method such as a fermentation method, an extraction method, or a synthesis method or commercially available amino acids or salts thereof can be used.

Specific examples of such amino acids include alanine, arginine, asparagine, aspartic acid, methionine, cystine, cysteine, glutamic acid, glutamine, glycine, threonine, histidine, valine, leucine, isoleucine, lysine, tryptophan, phenylalanine, tyrosine, proline, serine, and taurine. Examples of such salts of these amino acids include potassium and sodium. Furthermore, the amounts of these amino acids or salts thereof to be used herein are not particularly limited.

Examples of protein raw materials with low allergenicity that are used in the present invention are plant protein raw materials. Moreover, specific examples of such protein raw materials with low allergenicity include potato, sweet potato, rice, foxtail millet, barnyard millet, kaoliang, corn, pea, brewer's yeast, and baker's yeast. Furthermore, the amounts of these protein raw materials to be used herein can be appropriately determined and are not particularly limited.

Furthermore, when 2 or more types of raw materials containing proteins with low allergenicity are used, an effect of preventing the occurrence of a food allergy can be exerted at a level that is far superior to that in the cases of conventional pet foods, whereas the degree of reducing the risk of the occurrence of a food allergy is somewhat lowered compared with the use of 1 type of raw materials containing proteins with low allergenicity.

The above pet food can be processed into a dry pet food through heat-extrusion and molding using an extruder followed by swelling and foaming. In this way, a pet food that users can immediately feed their pets at any necessary times and that can be easily stored can be obtained. It becomes possible to raise a pet with only the pet food of the present invention and water, while keeping the pet health.

The present inventors have discovered that the risk of the occurrence of a food allergy reaction can be reduced and that users can conveniently feed their pets while maintaining pet health through feeding a pet subject to a food allergy with a pet food that contains no amino-acid-containing raw materials, but contains 1 or more types of amino acids, or with a pet food that is composed of 1, 2, or more types of protein-containing raw materials selected from potato, sweet potato, rice, foxtail millet, barnyard millet, kaoliang, corn, pea, brewer's yeast, and baker's yeast, in addition to 1 or more types of amino acids. An object of the present invention is to provide a pet food that can be conveniently used and that can reduce the risk of the occurrence of a food allergy reaction in pets subject to food allergies or pets suspected to be subject to food allergies through the combined use of amino acid(s) instead of protein(s) or the use of amino acid(s) and protein(s) with low allergenicity in a pet food.

### BEST MODE OF CARRYING OUT THE INVENTION

The present invention will be further described specifically. However, the technical scope of the present invention is not limited by the following examples.

### EXAMPLE 1

(1) Raw materials for a dog food having a composition as listed in Table 1 were prepared.

TABLE 1

| | |
|---|---|
| Starch, dextrins, and saccharides | 57 parts by weight |
| Potato protein | 10 parts by weight |
| Amino acids* | 7 parts by weight |
| Soybean oil | 15 parts by weight |
| Cellulose | 5 parts by weight |
| Vitamins and minerals | 6 parts by weight |

*Amino acids included alanine, arginine, asparagine, aspartic acid, methionine, cystine, cysteine, glutamic acid, glutamine, glycine, threonine, histidine, valine, leucine, isoleucine, lysine, tryptophan, phenylalanine, tyrosine, proline, serine, and taurine.

The amount of each amino acid used in Table I is as listed in Table 2 below.

TABLE 2

| | |
|---|---|
| Alanine | 1.50 parts by weight |
| Arginine | 1.00 parts by weight |
| Asparagine | 0.10 parts by weight |
| Aspartic acid | 0.10 parts by weight |
| Methionine | 0.40 parts by weight |
| Cystine | 0.10 parts by weight |
| Cysteine | 0.20 parts by weight |
| Glutamic acid | 0.10 parts by weight |
| Glutamine | 0.10 parts by weight |
| Glycine | 1.00 parts by weight |
| Threonine | 0.25 parts by weight |
| Histidine | 0.05 parts by weight |
| Valine | 0.25 parts by weight |
| Leucine | 0.30 parts by weight |
| Isoleucine | 0.25 parts by weight |
| Lysine | 0.35 parts by weight |
| Tryptophan | 0.20 parts by weight |
| Phenylalanine | 0.15 parts by weight |
| Tyrosine | 0.10 parts by weight |
| Proline | 0.10 parts by weight |
| Serine | 0.10 parts by weight |
| Taurine | 0.30 parts by weight |

*Amino acids contained

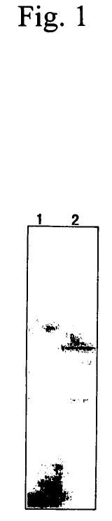

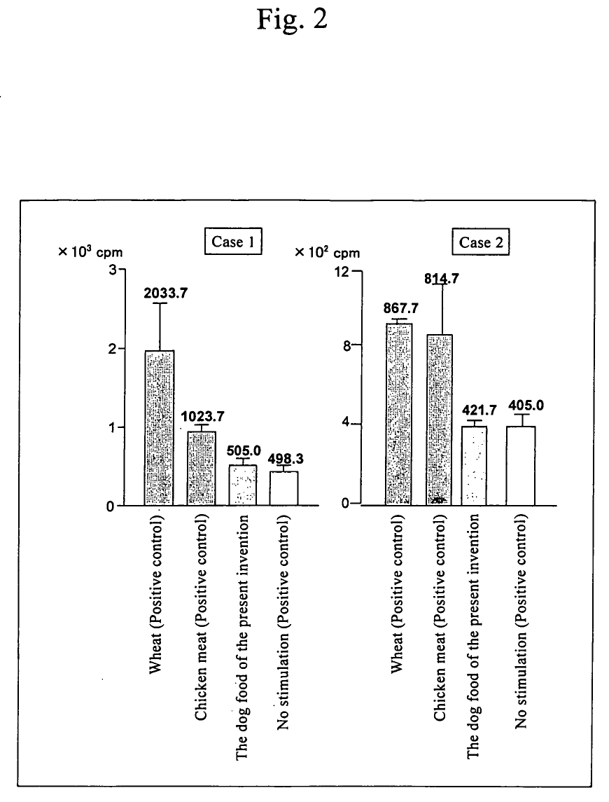

(2) The raw materials prepared in (1) above were sufficiently mixed using a ribbon mixer. The mixture was supplied to an extruder so that it could be extruded and molded, followed by swelling and foaming. The resultant was cut using a high-speed cutter, granulated to produce globular granules each with a diameter between 8 mm and 12 mm, and then dried using a dryer, thereby producing a dry dog food.
(3) A protein extracted from the dog food obtained in (2) above was subjected to Western blotting using an anti-dog IgE antibody to confirm whether or not serum IgE of a dog subject to a food allergy binds to the protein in this dog food. The result is as shown in FIG. 1. Whereas a protein to which dog IgE had bound was detected in the case of a positive control beef extract, no proteins were detected in the case of this dog food. Hence, it was revealed that the protein in this dog food does not bind to dog IgE.
(4) Furthermore, reaction of lymphocytes of 2 dogs subject to food allergies with the protein extracted from the dog food obtained in (2) above was examined. As shown in FIG. 2, the reactivity levels of the lymphocytes with this dog food were almost the same as those of unstimulated lymphocytes and were significantly lower than those of positive control food antigens. It was demonstrated that this dog food does not stimulate lymphocytes of dogs subject to food allergies and does not induce any food allergy reaction via a T-cell antigenic determinant.

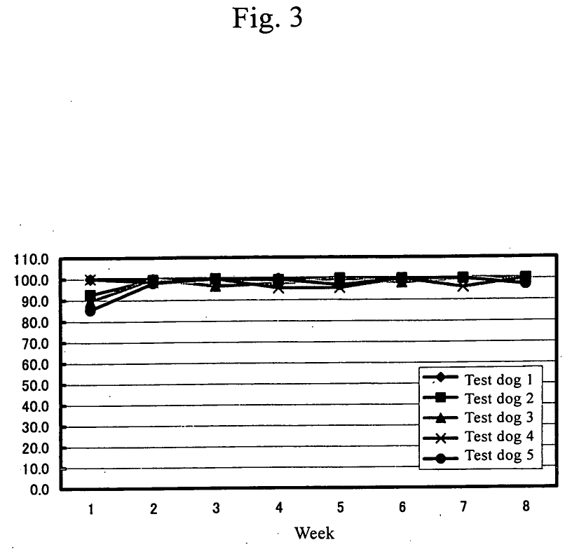

Dogs were fed with this dog food for 8 weeks. These subject dogs were fed with only water and this dog food during the 8 weeks of feeding. Each of these dogs was fed with this dog food in an amount that satisfied each dog's caloric requirement, which had been calculated based on the body weight of the dog. The dogs ate the dog food well. Immediately after the commencement of feeding with this dog food, some dogs seemed confused. Most dogs ate almost 100% of the dog food that had been fed them, indicating the high palatability of this dog food. FIG. 3 shows the proportions of the dog food intake to the amount of dog food that had been used for feeding.

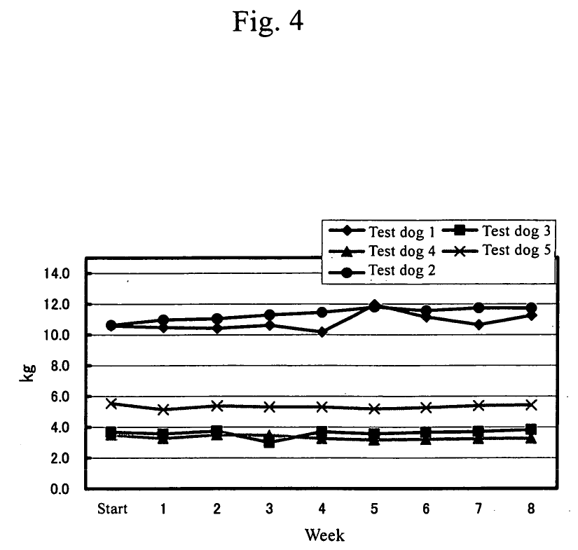

The body weights of the test dogs at the times of feeding were observed. No significant body weight losses or the like were observed, indicating that the dogs' health conditions were maintained. FIG. 4 shows body weight changes.

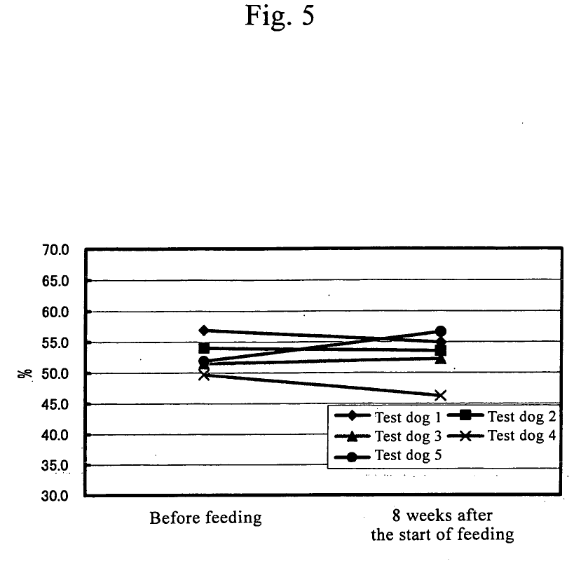

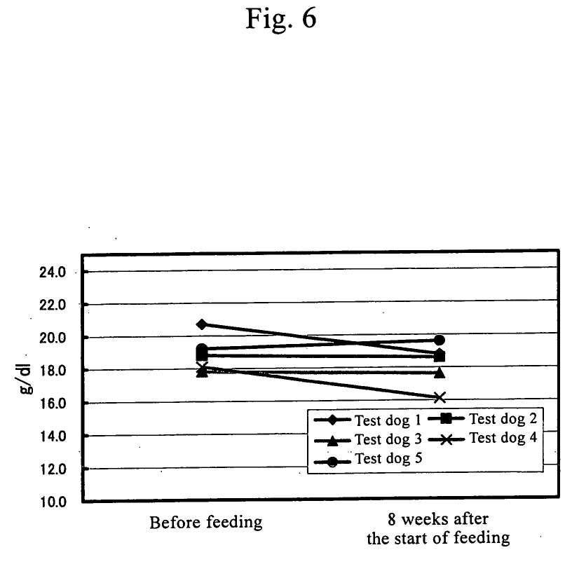

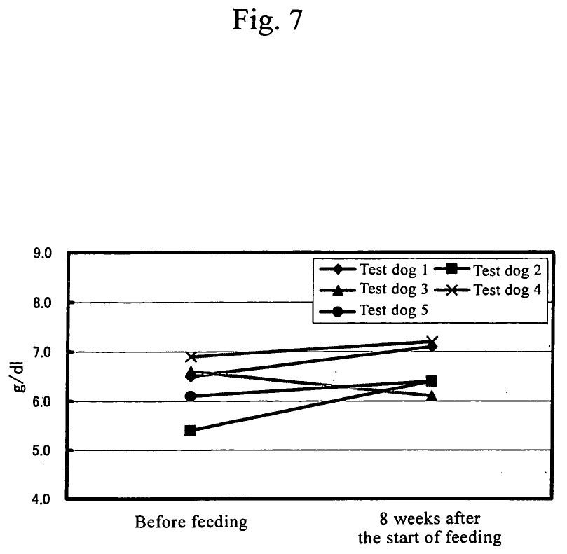

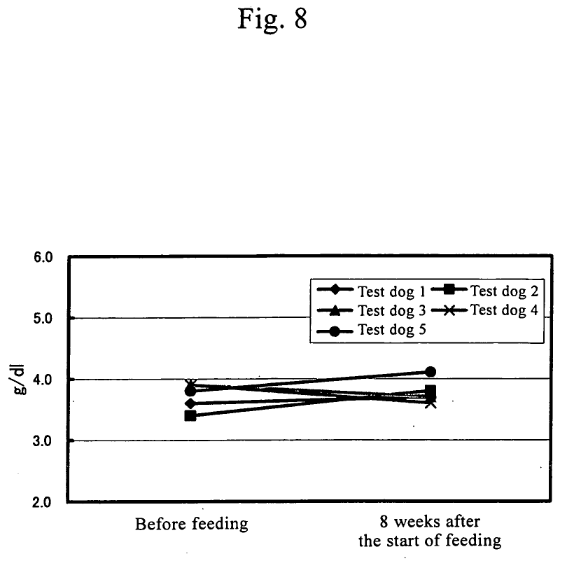

Also in blood tests conducted at the start of feeding and at 8 weeks after feeding, no signs indicating nutritional deficiency or the like were observed. Furthermore, no abnormalities were observed in clinical observance. Accordingly, it was demonstrated that the health of the test dogs fed with this dog food was maintained. FIG. 5 shows hematocrit changes. FIG. 6 shows hemoglobin changes. FIG. 7 and FIG. 8 show blood total protein changes and blood albumin changes, respectively.

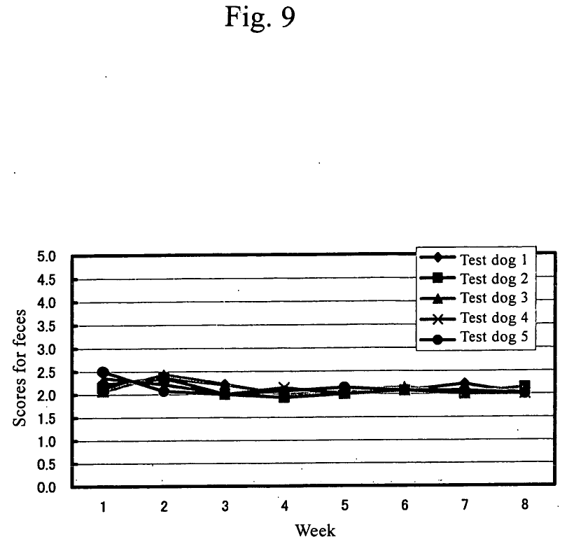

The properties of feces at the times of feeding were satisfactory. Normal defecation was observed. FIG. 9 shows the results of observing the properties of feces.

### EXAMPLE 2

A dog food (dog food for food allergy) composed of raw materials as listed in Table 3 and Table 4 below was prepared according to the above Example 1. Dogs subject to food allergies were fed with this dog food and then the itching scores of these dogs were determined.

TABLE 3

| | |
|---|---|
| Starch and saccharides | 45 parts by weight |
| Potato protein | 15 parts by weight |
| Amino acids* | 8 parts by weight |
| Soybean oil | 17 parts by weight |
| Cellulose | 7 parts by weight |
| Vitamins and minerals | 8 parts by weight |

TABLE 4

| | |
|---|---|
| Alanine | 1.50 parts by weight |
| Arginine | 1.20 parts by weight |
| Methionine | 0.40 parts by weight |
| Cysteine | 0.10 parts by weight |
| Glycine | 1.20 parts by weight |
| Threonine | 0.45 parts by weight |
| Histidine | 0.10 parts by weight |
| Valine | 0.40 parts by weight |
| Leucine | 0.60 parts by weight |
| Isoleucine | 0.45 parts by weight |
| Lysine | 0.40 parts by weight |
| Tryptophan | 0.20 parts by weight |
| Phenylalanine | 0.40 parts by weight |
| Tyrosine | 0.20 parts by weight |
| Serine | 0.20 parts by weight |
| Taurine | 0.20 parts by weight |

*Amino acids contained

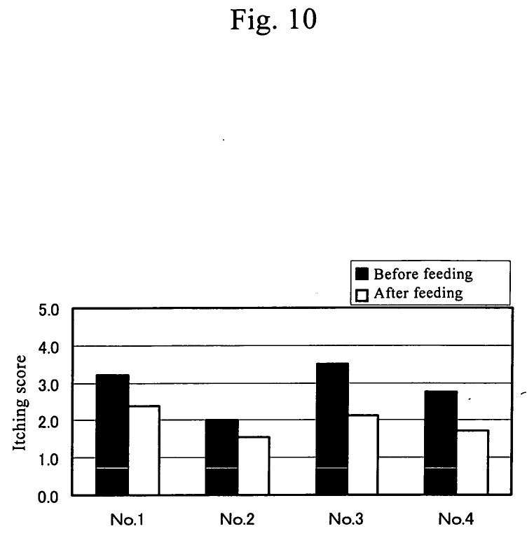

Table 5 and FIG. 10 show the itching scores at the times of feeding the dogs with this dog food.

TABLE 5

Itching score

| | Before | After |
|---|---|---|
| | feeding | feeding |
| No. 1 | 3.2 | 2.4 |
| No. 2 | 2.0 | 1.6 |
| No. 3 | 3.5 | 2.1 |
| No. 4 | 2.8 | 1.7 |

As shown in Table 5 and FIG. 10, when itching scores before feeding with this dog food were compared with those after feeding with this dog food, clear tendencies of decrease were observed after feeding.

In addition, evaluation standards for itching scores marked by dog owners in this example of experiment were as follows.
1: The dog does not scratch itself but scratches itself sometimes as a normal dog does.
2: The dog occasionally scratches itself or bites itself, but the dog seems quiet (calm) because it is patient with the degree of itching.
3: The dog scratches and bites itself, but the dog is patient with the degree of itching in most cases.
4: The dog frequently scratches and bites itself and vigorously moves around.
5: The dog always scratches and bites itself and seems to be in an extremely bad condition.
   The following 2 cases are described in detail.
   (a) Detailed description of case No.1
   (i) Changes (−1) in itching scores

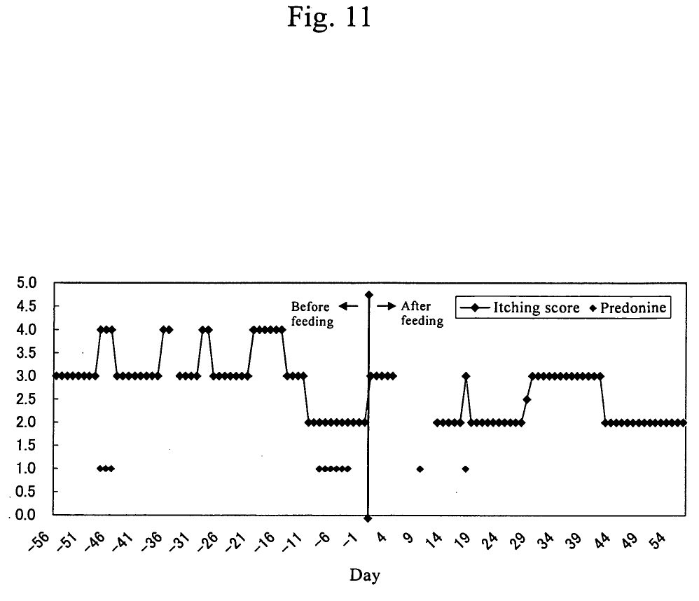

FIG. 11 shows changes (−1) in itching scores.

As shown in FIG. 11, itching scores before feeding changed from 3 to 4. Itching was further suppressed by administration of a steroid drug (predonine). Itching scores after feeding changed from 2 to 3 even without administration of the steroid drug. In this way, the amount of the steroid drug to be administered can be decreased.

(ii) Changes (−2) in itching scores

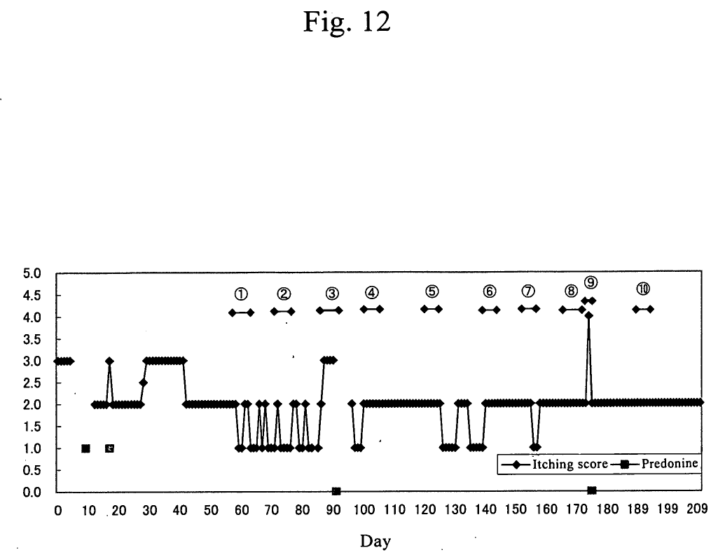

FIG. 12 shows changes (−2) in itching scores.

As shown in FIG. 12, itching scores before the start of feeding changed from 2 to 3. Portions indicated with “♦-♦” indicate periods during which the dog of this case was fed with foods that caused burdens thereto. During such periods, the dog was fed with the following foods in addition to the dog food. Periods (excluding that of foods (9)) were each of 7 days (the period for foods (9) was of 1 day). During the other periods, the dog was fed with the dog food.

(1) rice, (2) beef, (3) pork, (4) chicken meat, (5) beef (domestic), (6) beef (produced in Australia), (7) mackerel, (8) porgy, (9) porgy+cheese, and (10) tuna

When the dog was fed with pork and cheese that caused burdens thereto, the itching score increased and itching was suppressed using a steroid drug.

As shown in the results in FIG. 12, it was demonstrated that the food allergy in this case was due to at least pork and cheese functioning as food antigens and the symptoms due to this type of food allergy were not developed when the dog was fed with the dog food.

(b) Detailed Description about Case No. 2

(i) Changes in Itching Scores

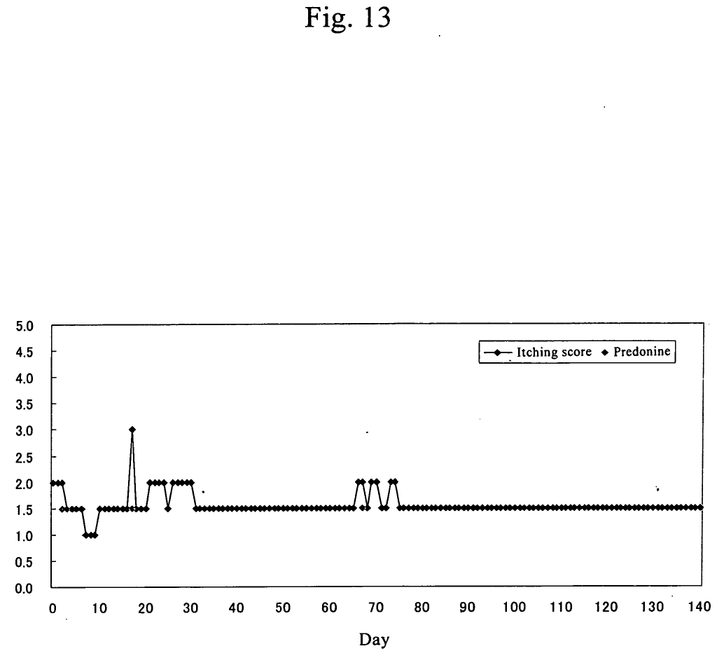

FIG. 13 shows changes in itching scores. As shown in the results in FIG. 13, itching scores after feeding (with this dog food) changed to around 1.5. It was thus observed that itching levels were low.

The dog of this case was allergic to beef as revealed by a separately conducted test where the dog had been fed with foods that caused burdens thereto. Furthermore, this case showed negative results in an antigen-specific IgE test for beef and an intradermal skin test (IDST) by which secretion of histamine or the like released via antigen-specific IgE is indicated. It was thus suggested that the food allergy in this case was not due to an allergic reaction occurring via IgE, but was mainly due to an allergic reaction occurring via lymphocytes.

(ii) Reaction of Lymphocytes

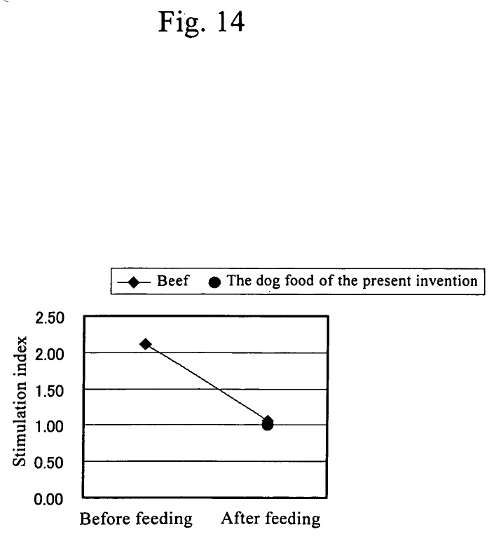

FIG. 14 shows the results of examining the reactivity of lymphocytes.

In the examination of the reactivity of lymphocytes as shown in FIG. 14, the stimulation index indicating the reactivity of lymphocytes against beef was greater than 2 before feeding with this dog food. That is, it was demonstrated that lymphocytes were reactive against beef. When the reactivity of lymphocytes was measured on day 84 of feeding, the reactivity against beef was lowered.

The lymphocytes did not react with the test food. It was thus demonstrated that this dog food does not induce any food allergy reaction via lymphocytes.

### EXAMPLE 3

Raw materials composing a dog food, as listed in Table 6 and Table 7 below, were prepared according to the above Example 1. In addition, the dog food is an example of a case in which amino acids were used instead of a protein raw material.

TABLE 6

| | |
|---|---|
| Starch, dextrins, and saccharides | 55 parts by weight |
| Amino acids* | 14 parts by weight |
| Soybean oil | 16 parts by weight |
| Cellulose | 7 parts by weight |
| Vitamins and minerals | 8 parts by weight |

TABLE 7

| | |
|---|---|
| Alanine | 1.00 parts by weight |
| Arginine | 1.30 parts by weight |
| Aspartic acid | 0.50 parts by weight |
| Methionine | 0.70 parts by weight |
| Cysteine | 0.30 parts by weight |
| Glutamic acid | 0.80 parts by weight |
| Glutamine | 0.10 parts by weight |
| Glycine | 1.20 parts by weight |
| Threonine | 0.85 parts by weight |
| Histidine | 0.35 parts by weight |
| Valine | 0.80 parts by weight |
| Leucine | 1.30 parts by weight |
| Isoleucine | 0.75 parts by weight |
| Lysine | 1.20 parts by weight |
| Tryptophan | 0.25 parts by weight |
| Phenylalanine | 1.00 parts by weight |
| Tyrosine | 0.40 parts by weight |
| Proline | 0.40 parts by weight |
| Serine | 0.60 parts by weight |
| Taurine | 0.20 parts by weight |

*Amino acids contained

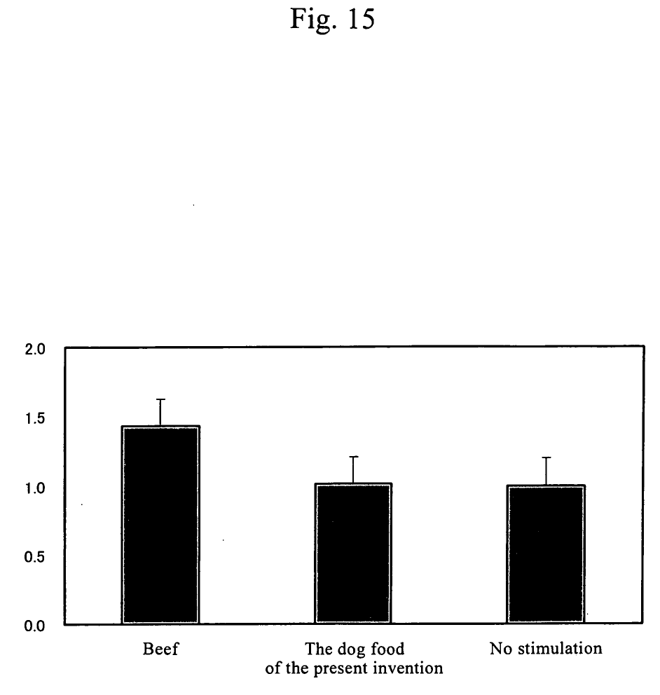

FIG. 15 shows the results of feeding a dog with the dog food.

The reaction of lymphocytes of one dog subject to a food allergy against a protein extracted from the dog food was examined. As shown in FIG. 15, the stimulation index indicating the reactivity of the lymphocytes to the dog food was lower than that in the case of beef and at almost the same level as that in the case of unstimulated lymphocytes. The lymphocytes did not react with the dog food and the dog food did not stimulate the lymphocytes of such a dog subject to a food allergy. Hence, it was demonstrated that the dog food does not induce any food allergy reactions via a T-cell antigenic determinant.

### INDUSTRIAL APPLICABILITY

When pets subject to food allergies are fed with the pet food according to the present invention, the occurrence of food allergy reactions can be reduced. Furthermore, the pet food has good palatability and the resulting properties of feces are satisfactory. Therefore, the pet food contributes to the maintenance of pet health.

1. A pet food for reducing food allergy reactions, which contains 1 or more types of amino acids or salts thereof instead of a protein raw material.

2. The pet food for reducing food allergy reactions according to claim 1, wherein the amino acid is 1 or more types of alanine, arginine, asparagine, aspartic acid, methionine, cystine, cysteine, glutamic acid, glutamine, glycine, threonine, histidine, valine, leucine, isoleucine, lysine, tryptophan, phenylalanine, tyrosine, proline, serine, and taurine.

3. A pet food for reducing food allergy reactions, which contains a plant protein raw material with low allergenicity and 1 or more types of amino acids or salts thereof.

4. The pet food for reducing food allergy reactions according to claim 3, wherein the plant protein raw material with low allergenicity is potato, sweet potato, rice, foxtail millet, barnyard millet, kaoliang, corn, or pea.

5. A pet food for reducing food allergy reactions, which contains 1, 2, or more types of raw materials selected from potato, sweet potato, rice, foxtail millet, barnyard millet, kaoliang, corn, pea, brewer's yeast, and baker's yeast, and 1 or more types of amino acids or salts thereof, instead of a protein raw material.
